(19) United States
(12) Patent Application Publication
(10) Pub. No.: US 2026/0127210 A1
(43) Pub. Date: May 7, 2026

(54) Generative AI Agent For Intelligent Document Processing And Management

(71) Applicant: IRON MOUNTAIN INCORPORATED, Portsmouth, NH (US)

(72) Inventors: Zhihong Zeng, Acton, MA (US); Shivam Mittal, Deoband (IN); Samriddhi Shakya, Washington, DC (US); Sushant Tiwari, New York, NY (US); Narasimha Goli, Tampa, FL (US)

(73) Assignee: IRON MOUNTAIN INCORPORATED, Portsmouth, NH (US)

(21) Appl. No.: 19/375,795

(22) Filed: Oct. 31, 2025

Related U.S. Application Data
(60) Provisional application No. 63/715,346, filed on Nov. 1, 2024.

(51) Int. Cl. G06F 16/34; G06F 3/04842; G06F 16/334; G06N 20/00; G06V 30/10

(52) U.S. Cl. CPC G06F 16/345; G06F 3/04842; G06F 16/3344; G06F 16/3347; G06N 20/00; G06V 30/10

(57) ABSTRACT

Systems and methods for an application using generative artificial intelligence and machine learning techniques to process documents in response to user prompts are provided. A method can include receiving a document and a user prompt including a request to perform a task. The method can include generating a semantic search query and a graph search query using the user prompt and the document. The method can include performing a semantic search of a vector database using the semantic search query and performing a graph search of a metadata graph using the graph search query. The method can include determining, using results of the semantic search and graph search, a context associated with the document and generating an output associated with the document by applying a machine learning model to an input comprising the context and document.

### CROSS REFERENCE TO RELATED APPLICATIONS

This application claims priority to U.S. Provisional Application No. 63/715,346, filed Nov. 1, 2025, the entirety of which is incorporated by reference herein for all purposes.

### TECHNICAL FIELD

The field of the present disclosure relates to document processing using machine learning techniques. In particular, the present disclosure relates to systems and methods for an application using generative artificial intelligence and machine learning techniques to process documents in response to user prompts.

### BACKGROUND

Document processing is an important endeavor allowing for sorting documents, classifying documents, interpreting contents of documents, and preparing documents for analysis. Existing data processing methods using machine learning techniques may be inadequate as the techniques may not provide context aware interactions and may not provide user-defined domain context.

### SUMMARY

Certain embodiments involve document processing using a user-friendly generative artificial intelligence agent. In one example, a computer-implemented method of document image processing is provided. The method can include receiving a document and a user prompt including a request to perform a task; generating a semantic search query and a graph search query using the user prompt and the document; performing a semantic search of a vector database using the semantic search query and performing a graph search of a metadata graph using the graph search query; determining, using results of the semantic search and graph search, a context associated with the document, wherein the context includes one or more of summaries of sections of the document, entities associated with the document, and keywords associated with the document; and generating an output associated with the document by applying a machine learning model to an input comprising the context and document.

In another example, a system is provided. The system can include one or more processors and one or more memories. The one or more memories can store computer-executable instructions that, when executed by the one or more processors, cause the one or more processors to: receive a document and a user prompt including a request to perform a task; generate a semantic search query and a graph search query using the user prompt and the document; perform a semantic search of a vector database using the semantic search query and performing a graph search of a metadata graph using the graph search query; determine, using results of the semantic search and graph search, a context associated with the document, wherein the context includes one or more of summaries of sections of the document, entities associated with the document, and keywords associated with the document; and generate an output associated with the document by applying a machine learning model to an input comprising the context and document.

In yet another example, a non-transitory computer-readable medium is provided. The non-transitory computer-readable medium can include instructions that are executable by one or more processors to cause the one or more processors to perform operations comprising: receiving a document and a user prompt including a request to perform a task; generating a semantic search query and a graph search query using the user prompt and the document; performing a semantic search of a vector database using the semantic search query and performing a graph search of a metadata graph using the graph search query; determining, using results of the semantic search and graph search, a context associated with the document, wherein the context includes one or more of summaries of sections of the document, entities associated with the document, and keywords associated with the document; and generating an output associated with the document by applying a machine learning model to an input comprising the context and document.

### BRIEF DESCRIPTION OF THE DRAWINGS

FIG. 1 shows a block diagram of a computing environment for providing a generative artificial intelligence agent, according to certain aspects of the present disclosure.

FIG. 2 shows a block diagram demonstrating an example flow diagram showing an example framework for providing a generative artificial intelligence agent, according to certain aspects of the present disclosure.

FIG. 3 shows a flow chart demonstrating a process for providing a generative artificial intelligence agent, according to certain aspects of the present disclosure.

FIG. 4 shows a block diagram demonstrating a scaled implementation of a generative artificial intelligence agent, according to certain aspects of the present disclosure.

FIG. 5 shows an example user interface for a generative artificial intelligence agent, according to certain aspects of the present disclosure.

FIG. 6 shows a block diagram of an example computing device, according to certain aspects of the present disclosure.

### DETAILED DESCRIPTION

The subject matter of embodiments of the present disclosure is described here with specificity to meet statutory requirements, but this description is not necessarily intended to limit the scope of the claims. The claimed subject matter may be implemented in other ways, may include different elements or steps, and may be used in conjunction with other existing or future technologies. This description should not be interpreted as implying any particular order or arrangement among or between various acts or elements except when the order of individual acts or arrangement of elements is explicitly described.

Certain aspects and examples of the disclosure relate to techniques that use generative artificial intelligence models to perform digital document processing and management tasks. The generative artificial intelligence model may be implemented in an application executed on a computing platform, user device, or cloud service provider infrastructure. The application may include a user interface to which users may provide input to select documents for the generative artificial intelligence model to process. Users may input prompts, such as by typing commands, to the generative artificial intelligence model to command or select various tasks for the generative artificial intelligence model to perform.

The application may use a generative artificial intelligence model including a large language model (LLM) or large multimodal model (LMM) to perform digital document processing and management tasks. Users may input prompts through a user interface to direct the generative artificial intelligence model to perform various tasks. Users may further select a generative artificial intelligence model from a list of models to perform the tasks. For example, users may upload a document, select a generative artificial intelligence model from a list of models, and input a prompt for the selected generative artificial intelligence model to perform the task. In one example, users may input a string such as “summarize this document” or “generate an expense table for expenses described in this document”. In further examples, users may select from a preset list of tasks to perform on documents.

The computing platform may include a user interface. By way of a non-limiting example the user interface may include three expandable columns: an agent configuration column, a chat area, and a status dashboard. Users may configure the generative artificial intelligence model by providing selections to the agent configuration column. Users may provide prompts to the chat area to request the generative artificial intelligence model perform tasks such as classifying documents, extracting data elements from documents, fixing errors in documents, generating summaries, reviewing metadata of the documents, and detecting and populating tables. The status dashboard may show metrics of the generative artificial intelligence model such as number of documents processed, number of tokens used in performing a task, taxonomy of the documents processed, and workflow status of user prompts. The user interface may further include multiple tabs for multiple chat streams. In some examples, the user interface may also support drag-and-drop document upload, access control for multi-user environments, and customizable dashboards that present analytics tailored to specific user roles or preferences. The interface may further support integration with external storage providers (e.g., cloud drives), enabling users to import and export documents seamlessly.

Certain examples described herein involve document processing using a user-friendly generative artificial intelligence agent. The generative artificial intelligence agent may include various machine learning techniques and models, such as including multi-modal or large language models, to receive various text/image/audio/video inputs and generate various text/image/audio/video outputs. Further, the generative artificial intelligence agent may be part of the application or cloud service which users may interact with through a user interface. The user interface may allow users to request that the generative artificial intelligence agent perform tasks and may include multiple chat streams across multiple tabs of the user interface. The user interface may further provide real-time feedback, suggestions for prompt refinement, and visualizations of document analytics to improve user experience and facilitate efficient document processing.

The generative artificial intelligence agent may perform various tasks to process and analyze documents such as by performing classification, extraction, document QA, summary generation, signature detection, table detection, etc. The generative artificial intelligence agent may also facilitate batch processing of documents, enable the scheduling of automated tasks, and allow for integration with third-party workflow and document management systems through APIs. The generative artificial intelligence agent is customizable by the user, which may enable users to: add/remove services (API, functions), add/remove user-defined python functions, add/build a vector database, and add/build a metadata graph which can be retrieved by query to generate relevant query context. The generative artificial intelligence agent may be further customizable by the user to provide analytics and insight display from customer document management (search and retrieval, data statistics). Customizability may extend to the configuration of model hyperparameters, security and privacy settings, and the creation of user-specific templates for repetitive tasks.

By way of another non-limiting example, the generative artificial intelligence agent may further include backend services that build and run workflows in real time based on user inputs (text prompt or selection), generate complex workflows including mixtures of sequential and parallel sub-workflow, provide context aware interaction such as chat history context and user-defined domain specific knowledge context, provide integration of multiple pretrained/custom model services and APIs, provide user-defined function integration on demand, export results and workflow, provide response with resource trace visualization to reduce hallucination such as but not limited to signature detection bounding boxes in a document, provide analytics and insight extraction from customer document management, and provide asynchronous large and batch document processing

### Exemplary System for Providing a Generative Artificial Intelligence Agent

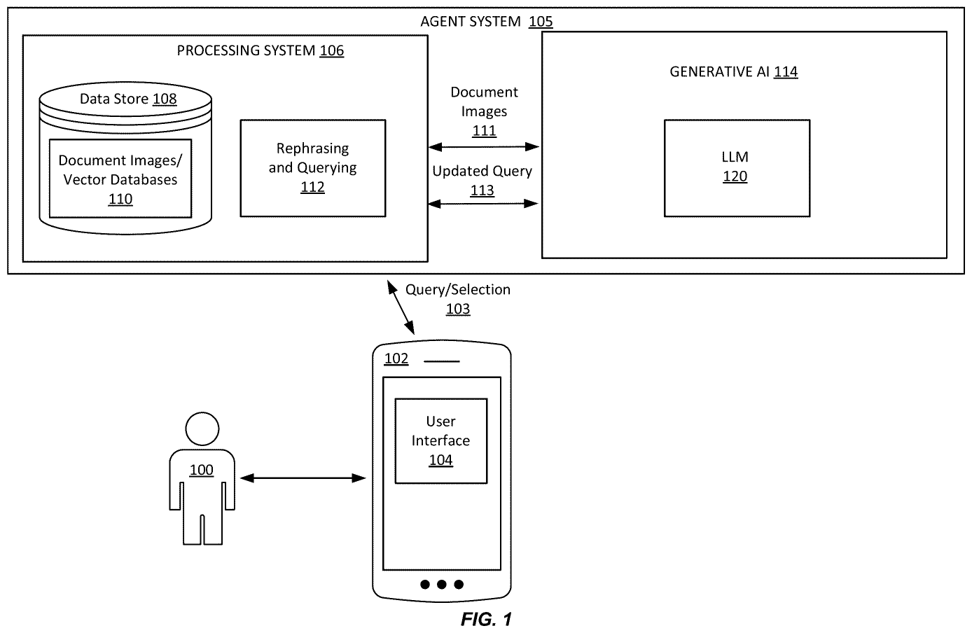

FIG. 1 shows a block diagram for providing an example artificial intelligence agent. By way of a non-limiting example intended to show an example system for providing a generative artificial intelligence agent, FIG. 1 includes an agent system 105. The agent system 105 includes a processing system 106 and a generative artificial intelligence system 114. In some examples, various elements of the processing system 106 and generative artificial intelligence system 114 may be performed by the same or different systems.

Users 100 may provide an input (e.g., user query/selection 103) to a user interface 104 of an application on a user device 102. The input may include a prompt or selection requesting the agent system 105 perform an action, such as summarizing a document, populating a chart with information from a document, and identifying parties in the document. The application and user device 102 may provide the user's input to the agent system 105.

The processing system 106 may receive the user query/selection. In some examples, the processing system 106 may rephrase the user query/selection and generate updated/rephrased queries 113. The system may rephrase inputs from the user (e.g., queries, prompts, and selections) to put the inputs in an appropriate form for the generative artificial intelligence system 114, including a large language model 120, to understand. In some examples, the processing system 106 includes a data store 108, which may include documents uploaded by a user, a vector database, and metadata graphs that the processing system 106 or generative artificial intelligence system 114 may retrieve based on a user's query to provide relevant query context. The generative artificial intelligence system 114 may receive data from the processing system 106 such as updated/rephrased queries 113, prompts, selections, and document images 111 and generate an output based on the received data. By way of non-limiting example, the generative artificial intelligence system 114 may use a large language model 120 to generate outputs based on the received data. The user interface 104 conveys the outputs generated by the large language model 120 using a display of user device 102.

### Exemplary Framework Architecture for a Generative Artificial Intelligence Agent

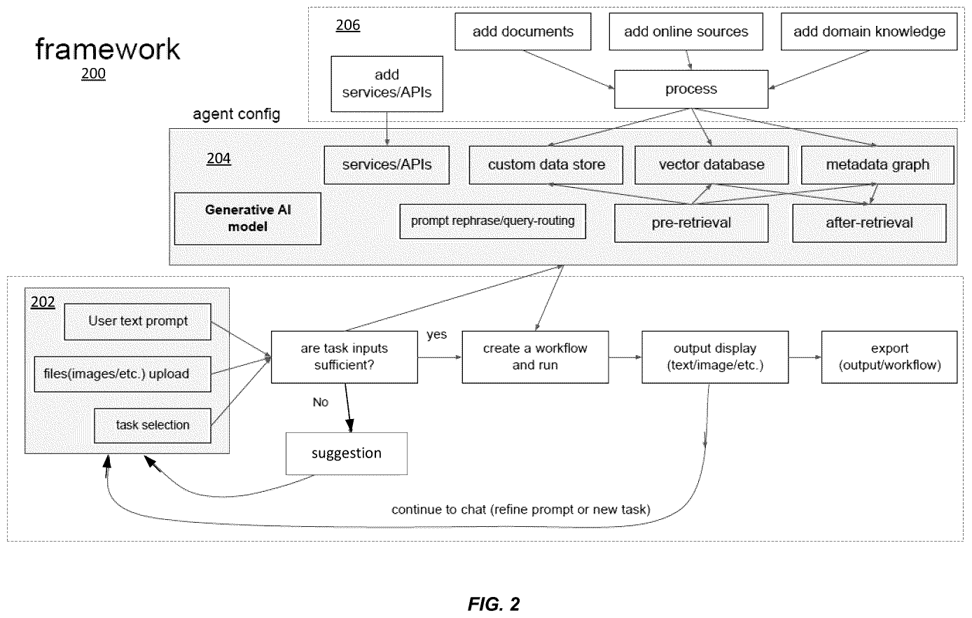

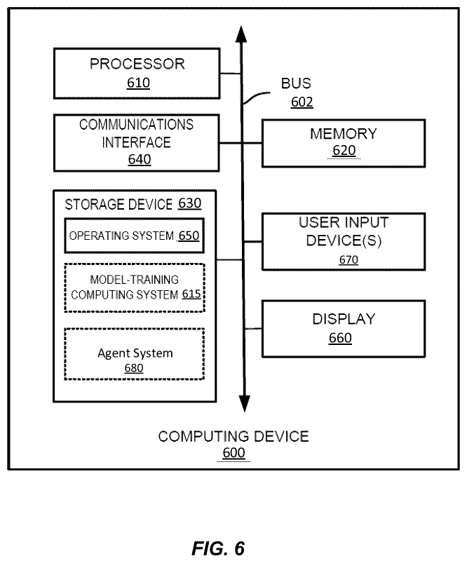

FIG. 2 shows a block diagram for providing example framework architecture 200 for a generative artificial intelligence agent. The framework architecture includes a user interface system 202, agent configuration system 204, and processing system 206. FIG. 2 may be implemented using cloud services, as further described in the block diagram for FIG. 1 or in a computing system such as the computing system further described in FIG. 6.

The example framework architecture 200 includes a user interface system 202 which users may provide input to select actions for the generative artificial intelligence agent to perform. For example, users may enter a text prompt into an input field, upload images/files for the generative artificial intelligence agent to review and select tasks for the generative artificial intelligence agent to perform.

The user interface system 202 may further include internal logic such as rule based processing that may determine whether the user text prompts, and task selection are sufficient for the agent configuration system to perform the user text prompt and task selection. When the user text prompt and task selection is not sufficient to perform a task, such as when the text prompt is incomplete or ambiguous, the user interface system 202 may provide suggestions to the user for updated prompts. When the text prompts and task selection are sufficient, the user interface system may provide the text prompt and task selection to the agent configuration system 204. The user interface system may further output responses from the agent configuration system 204 and create and export workflows to the user interface system 202 and/or other systems.

The agent configuration system 204 may include a generative artificial intelligence model, such as a large language model or other machine learning models. The agent configuration system 204 may include prompt rephrasing/re-routing of user text prompts and task selection for input to the generative artificial intelligence model. The agent configuration system may further include various systems for storing data, including a vector database and custom data store, which may store data associated with training the generative artificial intelligence model, data associated with results generated by the generative artificial intelligence model, inputs (which may include user text prompts, task selections, graph search queries, semantic search queries, metadata graphs) to the agent configurations system and generative artificial intelligence model, and data associated with user settings. The agent configuration system 204 may further communicate with various cloud services such as through application programming interfaces (APIs). In some examples, users may add or remove services (API, functions) and user-defined python functions to the agent configuration system 204.

The framework architecture 200 for a generative artificial intelligence agent may further include a processing system 206 to process documents and provide further information providing context to documents that may be used by the generative artificial intelligence model such as by adding online sources and domain knowledge. For example, the processing system 206 may process documents and images uploaded by the user such as performing optical character recognition (OCR) services. In some examples, the processing system 206 may be part of the user interface system 202 or part of the agent configuration system 204.

### Exemplary Flow Chart Providing a Generative Artificial Intelligence Agent

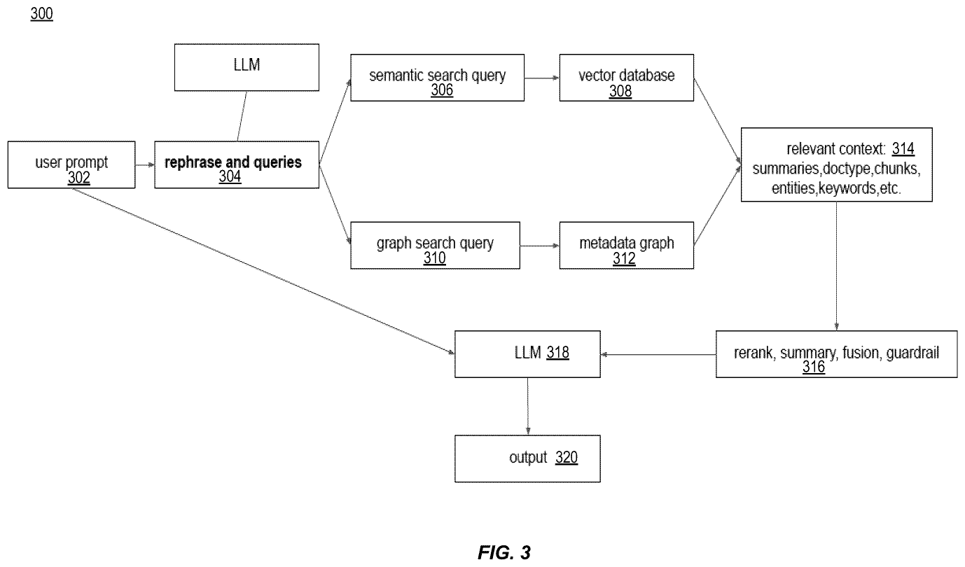

FIG. 3 illustrates an example depicts a flow chart of an example of a process 300 for providing a generative artificial intelligence agent for intelligent document processing. In some examples, some of the blocks in the flow chart of FIG. 3 are implemented in program code executed by a processor, for example, the processor in a general-purpose computer, mobile device, or server. In some examples, these blocks are implemented by a group of processors. In further examples the blocks shown in FIG. 3 are performed in a different order, concurrently, or one or more blocks may be skipped. Alternatively, in some examples, additional steps not shown in FIG. 3 may be performed.

At block 302, the process includes receiving a user prompt. An application, such as the application further described in the description of FIG. 1, may receive a user input to a user interface of the application. The user input may be a text prompt, or a selection from a list of options for tasks for a generative artificial intelligence model to perform on a document. For example, the user may enter a text prompt such as “summarize the terms of the attached agreement” and include an attachment of a document for the generative artificial intelligence model to analyze.

At block 304, the process includes rephrasing the user prompt and generating queries based on the user prompt. For example, a user may provide a user prompt at block 302 that may be ambiguous or not be in a form understood by the large language model (LLM). The computing platform may rephrase the user prompt for input to provide as input to the large language model (LLM).

At block 306 a generative artificial intelligence agent, such as the generative artificial intelligence agent further described in FIG. 1, generates a semantic search query based on the rephrased user prompt. The generative artificial intelligence agent may use natural language processing and further machine learning techniques and language processing techniques to generate a query of similar words and meaning as the prompt provided by the user. In some examples, the generative artificial intelligence agent tokenizes the rephrased user prompt and encodes it into an n-dimensional vector representation using a pretrained language model, such as a transformer-based sentence encoder. The encoding process may capture both the syntactic and semantic features of the prompt, allowing for nuanced retrieval of document content that aligns with an intent of the user prompt. The generative artificial intelligence agent may further augment the semantic query by incorporating contextual cues from prior chat history or document metadata, ensuring that the generated search query reflects both explicit and implicit user requirements.

At block 308, the generative artificial intelligence agent searches a vector database associated with the contents of the document to which the user's prompt is directed. The generative artificial intelligence agent may identify relevant information in the document, represented in the vector database, based on the semantic search query. Specifically, the generative artificial intelligence agent can compare the vector representation of the user prompt to precomputed vector embeddings of document sections, paragraphs, or entities stored within the vector database. In some examples, a nearest neighbor search algorithm, such as approximate nearest neighbor (ANN), may be utilized to efficiently retrieve the most semantically similar portions of the document. This process enables rapid and scalable identification of relevant text, tables, or other content, even across large corpuses of documents, by measuring cosine similarity or Euclidean distance between vectors. In some examples, the results may be ranked and filtered based on similarity scores and additional user-defined criteria.

At block 310, the generative artificial intelligence agent generates a graph search query based on the rephrased user prompt. The graph search query is a search query to identify relationships of sections and elements of the document with other sections and elements within the document, or to other sections and elements within other documents. The relationships may be demonstrated by commonalities in the metadata. For example, different sections of a document may have associated metadata that has a common editor or subject as another portion of a document or other documents. In an example implementation, the generative artificial intelligence agent can execute processing to parse metadata associated with the document, including attributes such as author, creation date, section headings, referenced entities, and document type, and construct or access a metadata graph wherein nodes represent document elements and edges represent relationships or shared attributes. The generative artificial intelligence agent can formulate a graph search query by identifying nodes and relationships that correspond to entities or concepts extracted from the user prompt. In some implementations, the generative artificial intelligence agent may utilize advanced graph traversal algorithms, such as breadth-first or depth-first search, or more sophisticated techniques such as graph embeddings or subgraph matching, to traverse the metadata graph and retrieve related elements based on explicit and inferred relationships.

At block 312, the generative artificial intelligence agent searches a metadata graph to identify data from the document related to the graph search query. For example, sections of the document may include metadata related to other sections of the document, or other documents. The generative artificial intelligence agent may search the metadata graph for portions of the document related to the graph search query. In some examples, the generative artificial intelligence agent can execute the constructed graph search query against the metadata graph, which may be implemented in a graph database (e.g., Neo4j, Amazon Neptune) or an in-memory graph data structure, to identify nodes and their associated content that are relevant to the user prompt. The generative artificial intelligence agent may aggregate results based on the strength of the relationships (e.g., number of shared attributes or proximity within the graph) and may combine these results with those from the semantic vector search to form a holistic understanding of the document context. The integration of semantic and graph search enables the agent to surface both direct textual matches and contextually or relationally relevant content, thereby enhancing the accuracy and depth of document analysis.

At block 314, the generative artificial intelligence agent determines relevant context from the provided document based on the results of the semantic search query and the graph search query. For example, the generative artificial intelligence agent may determine relevant context for the provided document by generating summaries of the document or chunks (e.g., sections) of the document, identifying the document type of the document, and identifying entities and keywords from the document.

At block 316, the generative artificial intelligence agent may edit the results from block 314 based on guardrails or other limitations placed on the generative artificial intelligence agent. For example, the generative artificial intelligence agent may include guardrails that define the type of language the generative artificial intelligence agent may use and the format the generative artificial intelligence agent may present information. The generative artificial intelligence agent may summarize and synthesize outputs from block 314 based on the guardrails placed on the generative artificial intelligence agent.

At block 318, the generative artificial intelligence agent may provide the edited results of block 316 to a large language model. The large language model may generate a response, which may include performing a task requested in the edited results of block 316. For example, the edited results of block 316 may include a prompt for the large language model to generate a summary of a page within a document. The large language model may perform a task requested in the edited results and may be provide an output at block 320 displayable to a user through a user interface. For example, the output may be the summary of the page within the document or an answer to a question posed in the user input.

### Exemplary Scaled Implementation of a Generative Artificial Intelligence Agent

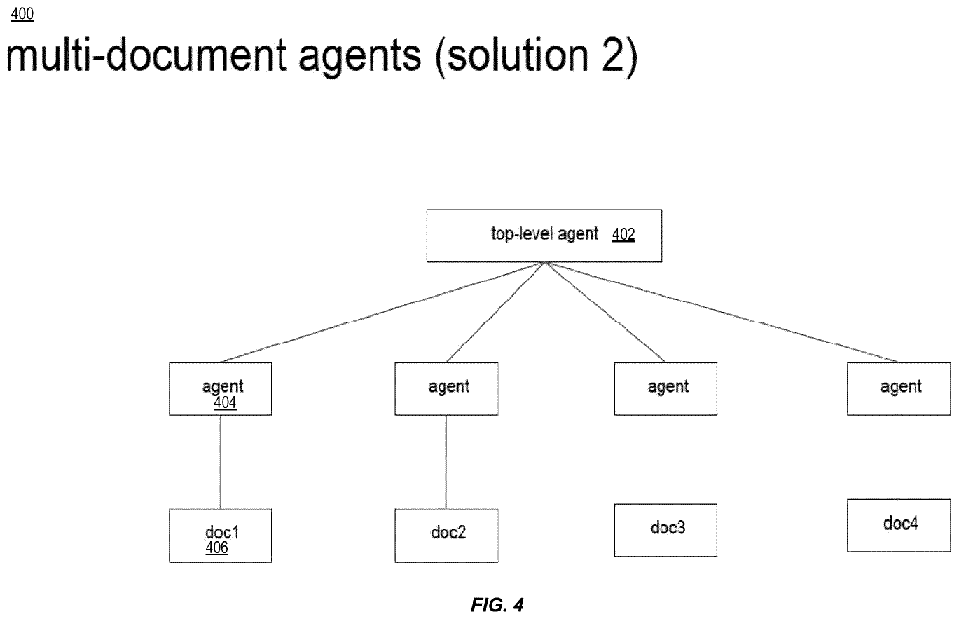

FIG. 4 shows an example scaled implementation 400 of the process described in FIG. 3 across a plurality of generative artificial intelligence agents 404. For example, FIG. 4 includes a top-level agent 402 configured to manage various generative artificial intelligence agents 404. The plurality of generative artificial intelligence agents may be multiple instances of the same generative artificial intelligence agent or may be different generative artificial intelligence agents using different machine learning techniques. The scaled implementation may provide for multiple documents 406 to be analyzed and processed concurrently allowing for batches of documents to be analyzed and processed.

### Exemplary User Interface for a Generative Artificial Intelligence Agent

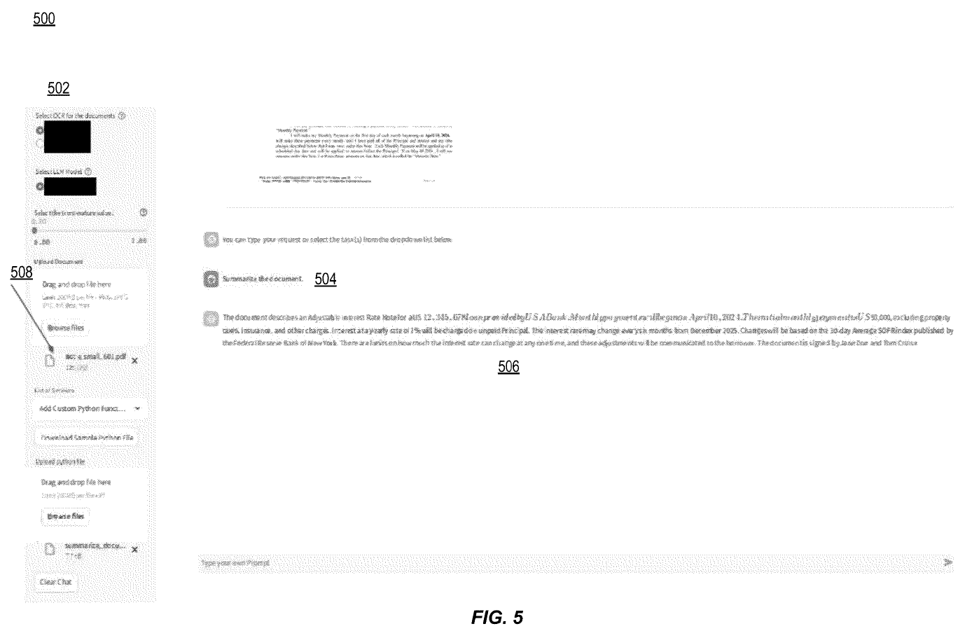

FIG. 5 shows an example user interface 500 for a generative artificial intelligence agent. By way of a non-limiting example, the user interface 500 includes an agent configuration column 502, a task input section 504, and a task output section 506.

The agent configuration column 502 includes various options for the user to configure or select the generative artificial intelligence model performing the tasks. Users may choose various processing techniques, such as optical character recognition (OCR) services to perform character recognition on uploaded documents. For example, users may select OCR services from various service providers. In some examples, such as further described in the description of FIG. 2, the OCR services may provide various processing tasks in preparation for the document being analyzed by the generative artificial intelligence model. In some implementations, the agent configuration column 502 may further allow users to specify language preferences, model confidence thresholds, and output formats (e.g., PDF, DOCX, CSV) for processed results. Users may also configure notifications for task completion or errors and set up recurring document processing schedules.

Users may further select a generative artificial intelligence model from a list of models from various providers. Agent configuration column 502 may provide users to mix and match various document processing services with various generative artificial intelligence models, allowing users flexibility in adjusting the generative artificial intelligence agent. By way of a non-limiting example, a first OCR service may have higher accuracy in identifying handwritten text in comparison to a second OCR service. Users may select the first OCR service more accurate in identifying handwritten information when requesting the generative artificial intelligence model analyze a handwritten document. Further, users may select a generative artificial intelligence model from a list of generative artificial intelligence model suited for the task the user intends to select. Users may select a generative artificial intelligence model from a list of generative artificial intelligence model. In documents with various tables, such as a spreadsheet, users may select the more accurate OCR service in identifying characters and may select the generative artificial intelligence model to analyze the document.

The agent configuration column 502 may further include a file upload section 508. Users may upload files, such as documents, videos, music, and other types of files to be analyzed by a generative artificial intelligence.

Users may provide prompts or selections at the task input section 504. For example, users may type a prompt such as “summarize this document” or “generate a table based on values in the document”. In some examples, the user may select from a list of task options which task for the generative intelligence model to perform on files uploaded at the file upload section 508.

The user interface may display an output from the generative artificial intelligence at the task output section 506. For example, a user may request the generative artificial intelligence provide a table of values associated with a document. The user interface may convey the table of values in the task output section 506.

While FIG. 5 is described above with a general overview of the user interface 500, other features of the user interface 500 described herein are depicted in additional examples of the user interface 500 provided in Appendix A.

### Exemplary Computing Device

FIG. 6 shows an example computing device 600 suitable for implementing aspects of the techniques and technologies presented herein. The example computing device 600 includes a processor 610 which is in communication with a memory 620 and other components of the computing device 600 using one or more communications buses 602. The processor 610 is configured to execute processor-executable instructions stored in the memory 620 to perform secure data protection and recovery according to different examples, such as part or all of the example process 300 or other processes described above with respect to FIGS. 1-5. In an example, the memory 620 is a non-transitory computer-readable medium that is capable of storing the processor-executable instructions. The computing device 600, in this example, also includes one or more user input devices 670, such as a keyboard, mouse, touchscreen, microphone, etc., to accept user input. The computing device 600 also includes a display 660 to provide visual output to a user. In other examples of a computing device (e.g., a device within a cloud computing system), such user interface devices may be absent.

The computing device 600 can also include or be connected to one or more storage devices 630 that provides non-volatile storage for the computing device 600. The storage devices 630 can store an operating system 650 utilized to control the operation of the computing device 600. The storage devices 630 can also store other system or application programs and data utilized by the computing device 600, such as modules implementing the functionalities provided by the model-training computing system 615, agent system 680, or any other functionalities described above with respect to FIGS. 1-5. The storage devices 630 might also store other programs and data not specifically identified herein.

The computing device 600 can include a communications interface 640. In some examples, the communications interface 640 may enable communications using one or more networks, including: a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate arrays (FPGAs) specifically, to execute the various methods. For example, examples can be implemented in digital electronic circuitry, or in computer hardware, firmware, software, or in a combination thereof. In one example, a device may include one or more processing devices, such as a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media (for example, computer-readable storage media) that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C. For the purposes of the present document, the phrase “A is based on B” means “A is based on at least B”.

Different arrangements of the components depicted in the drawings or described above, as well as components and steps not shown or described are possible. Similarly, some features and sub-combinations are useful and may be employed without reference to other features and sub-combinations. Embodiments of the presently subject matter have been described for illustrative and not restrictive purposes, and alternative embodiments will become apparent to readers of this patent. Accordingly, the present disclosure is not limited to the embodiments described above or depicted in the drawings, and various embodiments and modifications may be made without departing from the scope of the claims below.

What is claimed is:

1. A computer-implemented method of document image processing, the method comprising:
receiving a document and a user prompt including a request to perform a task;
generating a semantic search query and a graph search query using the user prompt and the document;
performing a semantic search of a vector database using the semantic search query and performing a graph search of a metadata graph using the graph search query;
determining, using results of the semantic search and graph search, a context associated with the document, wherein the context includes one or more of summaries of sections of the document, entities associated with the document, and keywords associated with the document; and
generating an output associated with the document by applying a machine learning model to an input comprising the context and document.

2. The computer-implemented method of claim 1, wherein the machine learning model comprises a large language model or a multimodal model.

3. The computer-implemented method of claim 1, wherein the output comprises a summary, a table, an answer to a question associated with the user prompt, or any combination thereof.

4. The computer-implemented method of claim 1, further comprising:
generating for display, via a display of a user device, a user interface including an agent configuration section, a task input section, and a task output section;
receiving, at the agent configuration section, a user selection of the document from a plurality of documents, a machine learning model selection from a plurality of machine learning models, and an optical recognition service from a plurality of optical recognition services;
receiving, at the task input section, the user prompt associated with the task to be performed by the machine learning model; and
in response to receiving the document, the machine learning model selection, the optical recognition service, and the user prompt:
processing the document using the optical recognition service to thereby generate a processed document;
invoking the machine learning model to perform the task on the processed document and generate an output associated with the task; and
displaying, via the display of the user device, the output at the task output section of the user interface.

5. The computer-implemented method of claim 1, wherein generating the semantic search query comprises encoding the user prompt into a vector representation using a transformer-based language model, and wherein the semantic search comprises performing a nearest neighbor search in the vector database using cosine similarity or Euclidean distance metrics.

6. The computer-implemented method of claim 1, wherein the vector database stores precomputed vector embeddings of document sections, paragraphs, or entities, and wherein performing the semantic search returns content based at least in part on a similarity to an encoded user prompt.

7. The computer-implemented method of claim 1, wherein generating the graph search query comprises extracting entities and relationships from the user prompt and mapping them to nodes and edges in the metadata graph, and wherein the method further comprises:
searching the metadata graph by traversing nodes and edges using a graph traversal algorithm to identify document elements that share metadata attributes associated with the user prompt.

8. The computer-implemented method of claim 1, further comprising:
combining results of the semantic search and the graph search;
ranking the results to extract a most relevant context for processing the document with the machine learning model; and
labeling the most relevant context as the context.

9. A system comprising:
one or more processors; and
one or more memories storing computer-executable instructions that, when executed by the one or more processors, cause the one or more processors to:
receive a document and a user prompt including a request to perform a task;
generate a semantic search query and a graph search query using the user prompt and the document;
perform a semantic search of a vector database using the semantic search query and performing a graph search of a metadata graph using the graph search query;
determine, using results of the semantic search and graph search, a context associated with the document, wherein the context includes one or more of summaries of sections of the document, entities associated with the document, and keywords associated with the document; and
generate an output associated with the document by applying a machine learning model to an input comprising the context and document.

10. The system of claim 9, wherein the machine learning model comprises a large language model or a multimodal model.

11. The system of claim 9, wherein the output comprises a summary, a table, an answer to a question associated with the user prompt, or any combination thereof.

12. The system of claim 9, wherein the instructions further cause the one or more processors to:
generate for display, via a display of a user device, a user interface including an agent configuration section, a task input section, and a task output section;
receive, at the agent configuration section, a user selection of the document from a plurality of documents, a machine learning model selection from a plurality of machine learning models, and an optical recognition service from a plurality of optical recognition services;
receive, at the task input section, the user prompt associated with the task to be performed by the machine learning model; and
in response to receiving the document, the machine learning model selection, the optical recognition service, and the user prompt:
process the document using the optical recognition service to thereby generate a processed document;
invoke the machine learning model to perform the task on the processed document and generate an output associated with the task; and
display, via the display of the user device, the output at the task output section of the user interface.

13. The system of claim 9, wherein generating the semantic search query comprises encoding the user prompt into a vector representation using a transformer-based language model, and wherein the semantic search comprises performing a nearest neighbor search in the vector database using cosine similarity or Euclidean distance metrics.

14. The system of claim 9, wherein the vector database stores precomputed vector embeddings of document sections, paragraphs, or entities, and wherein performing the semantic search returns content based at least in part on a similarity to an encoded user prompt.

15. The system of claim 9, wherein generating the graph search query comprises extracting entities and relationships from the user prompt and mapping them to nodes and edges in the metadata graph, and wherein the instructions further cause the one or more processors to:
search the metadata graph by traversing nodes and edges using a graph traversal algorithm to identify document elements that share metadata attributes associated with the user prompt.

16. The system of claim 9, wherein the instructions further cause the one or more processors to:
combine results of the semantic search and the graph search;
rank the results to extract a most relevant context for processing the document with the machine learning model; and
label the most relevant context as the context.

17. A non-transitory computer-readable medium comprising instructions that are executable by one or more processors to cause the one or more processors to perform operations comprising:
receiving a document and a user prompt including a request to perform a task;
generating a semantic search query and a graph search query using the user prompt and the document;
performing a semantic search of a vector database using the semantic search query and performing a graph search of a metadata graph using the graph search query;
determining, using results of the semantic search and graph search, a context associated with the document, wherein the context includes one or more of summaries of sections of the document, entities associated with the document, and keywords associated with the document; and
generating an output associated with the document by applying a machine learning model to an input comprising the context and document.

18. The non-transitory computer-readable medium of claim 17, wherein the machine learning model comprises a large language model or a multimodal model.

19. The non-transitory computer-readable medium of claim 17, wherein the output comprises a summary, a table, an answer to a question associated with the user prompt, or any combination thereof.

20. The non-transitory computer-readable medium of claim 17, wherein the instructions further cause the one or more processors to perform operations comprising:
generating for display, via a display of a user device, a user interface including an agent configuration section, a task input section, and a task output section;
receiving, at the agent configuration section, a user selection of the document from a plurality of documents, a machine learning model selection from a plurality of machine learning models, and an optical recognition service from a plurality of optical recognition services;
receiving, at the task input section, the user prompt associated with the task to be performed by the machine learning model; and
in response to receiving the document, the machine learning model selection, the optical recognition service, and the user prompt:
processing the document using the optical recognition service to thereby generate a processed document;
invoking the machine learning model to perform the task on the processed document and generate an output associated with the task; and
displaying, via the display of the user device, the output at the task output section of the user interface.
